(19) United States
(12) Patent Application Publication
(10) Pub. No.: US 2016/0054203 A1
(43) Pub. Date: Feb. 25, 2016

(54) Method of Filling a Sample Chamber

(71) Applicant: GAIM LIMITED, Derbbyshire (GB)

(72) Inventor: Mark Pattinson, Derbyshire (GB)

(21) Appl. No.: 14/780,654

(22) PCT Filed: Mar. 27, 2014
(86) PCT No.: PCT/GB2014/050968

§ 371 Date: Sep. 28, 2015

(30) Foreign Application Priority Data
Mar. 27, 2013 (GB) 1305645.2

(51) Int. Cl. G01N 1/20

(52) U.S. Cl. CPC G01N 1/20

(57) ABSTRACT

There is described a method of filling a sample chamber with a particulate material, said method comprising the steps of: opening an inlet valve to allow only a portion of the particulate material into the sample chamber; drawing air through the particulate material from the base of the sample chamber; closing the inlet valve is closed and opening a flow control valve to apply compression to the particulate material for a set period of time; releasing the pressure; and repeating the steps until the sample chamber is full.

### FIELD OF THE INVENTION

The present invention relates to a method and arrangement of flow components.

Particularly the invention relates to a method and arrangement of flow components for the filling of a sample chamber that allows the compression of a sample of, for example, a particulate material, such as a powder, to fill a sample chamber whilst maximising the packing ratio of the particulate material and minimising the voidage within the sample.

### BACKGROUND OF THE INVENTION

There are many industries that involve the pneumatic conveying of particulate, e.g. powdered materials. Many of these industries require sampling of the materials for various testing. Whilst often this sampling is of a manual nature, it is increasingly desirable that these sampling processes are automated.

For certain processes of measurement, particularly microwave based testing, it is important to have a sample chamber or interrogation chamber that is full with the particulate material, so as to avoid spurious or inaccurate readings.

In addition, the accuracy of the readings sample can also be affected by voids in the sample. A manual operator can perform actions to condition the sample by a qualitative process. Unfortunately, this might vary from user to user, particularly as the user cannot look inside a sample for voids. Machine or automated vision systems may address the issue and there has been some success with x-raying particulate samples. However, for most processes this cost conducting x-ray measurements on particulate sample, particularly on a large scale, can be is excessive and therefore prohibitive.

It is possible to utilise the loading of sample chambers or cells to obtain a mass of material, but in some processes this can be unsuitable. However, a mass signal does not indicate what material is actually in the interrogation chamber or cell, simply what mass of material is residing in the loaded chamber or cell.

Methods of compressing the sample into a known volume are not uncommon, particularly when dealing with large scale samples. Such methods tend to utilise either hydraulic rams or air to compress the particulate, material into a space. However, the use of hydraulic rams can lead to contamination and may add significant servicing issues to automated systems. Whilst using air compression can lead to the a problem of how to release the air pressure at such a rate without the particulate material “springing up” and leaking from the interrogation area.

### SUMMARY OF INVENTION

The method of the present invention works to prevent this “springing up” of particulate material by gently relieving the air pressure and also by drawing air through the sample to prevent the movement of material. The method also allows sample chamber to be filled in layers allowing each individual layer of particulate material to be sufficiently compressed.

Thus, according to a first aspect of the invention there is provided a method of filling a sample chamber with a particulate material, said method comprising the steps of:
(i) opening an inlet valve to allow only a portion of the particulate material into the sample chamber;
(ii) drawing air through the particulate material from the base of the sample chamber;
(iii) closing the inlet valve is closed and opening a flow control valve to apply compression to the particulate material for a set period of time;
(iv) releasing the pressure; and
(v) repeating steps (i) to (iv) until the sample chamber is full.

The invention described herein has been created to compress powder into an interrogation cell or chamber for the purposes of accurate measurement by some external device.

The invention is designed to allow the powder to be compressed eliminating voids and maximising the packing ratio. This is done to minimise errors in the analysis of the powder.

The inlet valve may comprise a T-piece connector which has a valve attached to it. In a preferred aspect if the invention the inlet valve comprises a pinch valve. A pinch valve is a control valve that uses a pinching effect to obstruct flow of the particulate material. The use of a pinch valve is intended to remove any problems associated with controlling the flow of cohesive, abrasive or corrosive materials. The major components of the pinch valve comprise a body, sleeve and an actuator, wherein the sleeve contains the particulate material. The sleeve may comprise a flexible, e.g. rubber, sleeve, allowing the valve to close droptight around solids—solids that would typically be trapped by the seat or stuck in crevices in globe, diaphragm, butterfly, gate, or ball valves. However, it will be understood by the person skilled in the art that the sleeve material may be selected upon the corrosiveness, abrasiveness, etc. of the particulate material.

A branch of the T-piece connector may be connected to another T-piece to which a 3-way flow control valve and optionally another pinch valve are connected. This second pinch valve is not essential for the method of the invention, but may be advantageous in enabling the sample of particulate material to be purged away.

Preferably, the lower portion of the sample chamber comprises a machined conical region e.g. frusto conical base region. The base of the conical region will generally be provided with a ball valve, for example comprising an aperture and a neoprene ball. In use, the conically shaped region and the ball valve are situated beneath the particulate material in the sample chamber, so that material in this area does not affect any measurement. The conical region is connected to a vacuum pump, e.g. a venturi pump, or eductor, which draws an amount of air from beneath the sample chamber. This air is constantly drawn from the sample chamber.

After a portion of the particulate material sample is placed in the sample chamber the pinch valve is closed and the flow control valve is opened and compression is applied to the particulate material. The value of the compression pressure may vary and may depend upon, inter alfa, the nature of the particulate material being compressed. Generally, the compressed particulate material is held for about 5 to about 20 seconds, e.g. about 10 seconds, before the flow control valve slowly relieves the pressure. The gradient of this release may also depend upon the nature of the particulate material.

The usual setting is to release the maximum pressure over a substantially linear gradient over a period of from about 10 to about 30 seconds, e.g. about 20 seconds.

This air being constantly drawn through the chamber, as referred to in step (ii) above, will represents a small fraction of the compression pressure, e.g. from about 1/40^{th} to about 1/10^{th} of the compression pressure, e.g. about 1/20^{th} the compression pressure.

Steps (i) to (iv) may be repeated as often as is necessary, however, it is generally repeated about 2 to 4 times, e.g. about 3 times. The sample chamber will usually be provided with an attenuation monitor, such as a microwave attenuation monitor.

Thus, in the method of the invention steps (i) to (iv) may be repeated until the attenuation monitor detects no further change in attenuation. The process repeats as it does for the cone filling process, but the microwave attenuation monitor looks at how full the sample is. This process lays down layer after layer of powder on top of each other and makes sure that each layer is as tightly pack as possible by forcing the air out of the material. When the attenuation does not change anymore after a compression the sample chamber is considered to be full. Once this has been achieved the actual measurement method can be carried out.

According to a further aspect of the invention there is provided a sample chamber system suitable for a particulate material, said system comprising:
a sample chamber suitable for housing a particulate material; the sample chamber being connected to an inlet valve suitable for the introduction of particulate material;
the sample chamber also being connected at its base to a vacuum pump suitable for drawing air through the particulate material from the base of the sample chamber;
the sample chamber being further connected to a flow control valve to allow compression of the particulate material.

The invention described here has been created to compress powder into an interrogation cell or chamber for the purposes of accurate measurement by some external device.

The method and system of the invention may suitably be used in conjunction with a sample of any known particulate material. Preferably, the particulate material is a powdered material. Thus, the particulate material can comprise a bulk material, such as, limestone, cement or fossil fuels, e.g. coal, or solid waste ash from burning fossil fuels, such as coal.

### BRIEF DESCRIPTION OF THE DRAWINGS

The invention will now be described solely by way of example and with reference to the accompanying drawings in which:

FIG. 1 is a schematic representation illustrating an approximated set up for the method and system of the invention;

FIGS. 2(a) to (e) are schematic representations of the filling of the sample chamber; and

FIG. 3 is a graph illustrating the profile of the compression air and its relief.

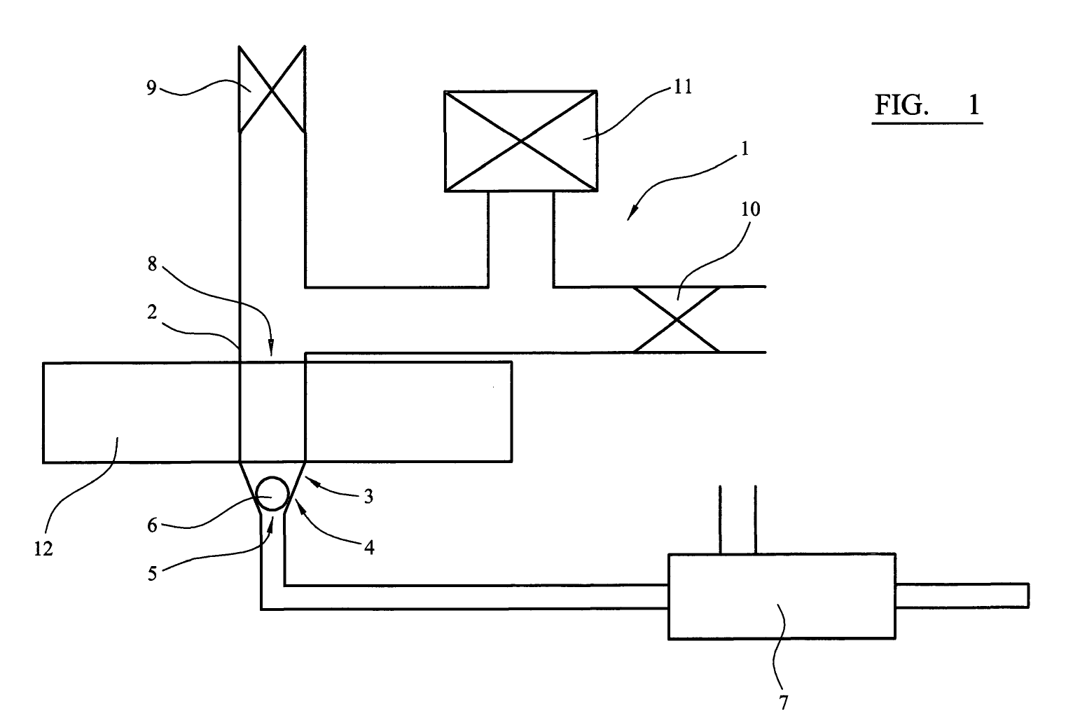

Referring to FIG. 1, a sample chamber system 1 suitable for a particulate material comprises a sample chamber 2 provided a base 3 with a frusto conical region 4. The frusto conical region 4 is provided with an aperture 5 and a ball valve 6. The apertured frusto conical region 4 is connected to a vacuum pump or eductor pump 7.

An inlet portion 8 of the sample chamber 2 is connected to a first pinch valve 9, a second pinch valve 10 and a flow control valve 11.

The sample chamber 2 is also provided with an attenuation monitor 12, such as a microwave attenuation monitor.

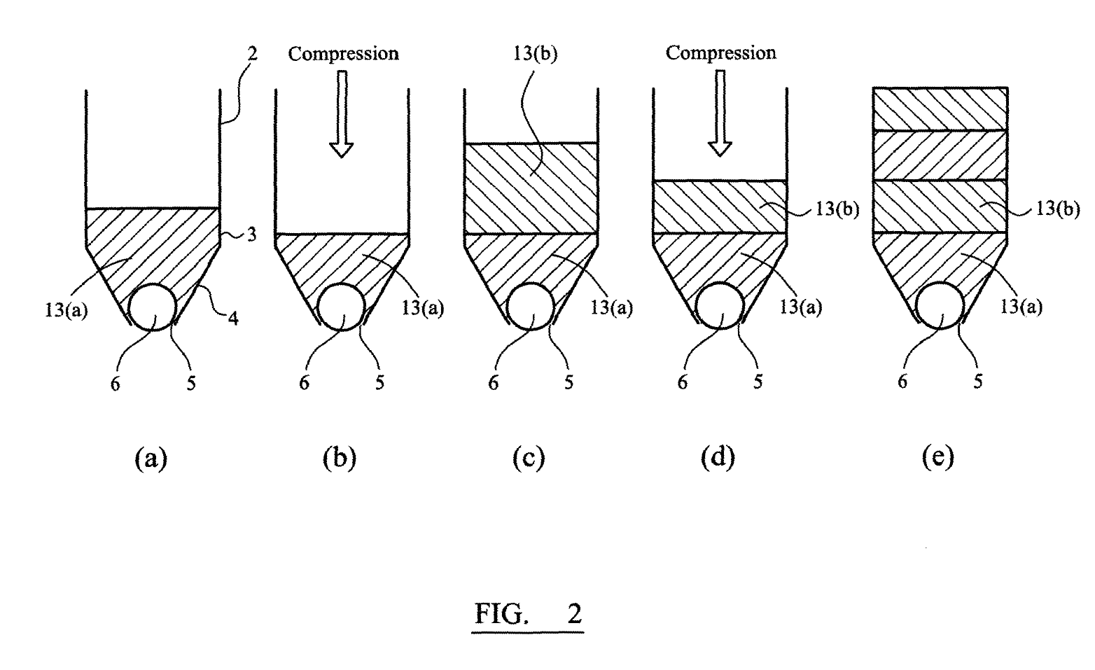

Referring to FIGS. 2(a) to (e), a sample chamber 2 suitable for a particulate material is provided a base 3 with a frusto conical region 4. The frusto conical region 4 is provided with an aperture 5 and a ball valve 6. A first fraction of the particulate material 13(a) is introduced into the sample chamber 2 and air is drawn through the particulate material 13(a) and the apertured ball valve 6. In FIG. 2(b) compression is then applied to the particulate material 13(a).

In FIG. 2(c) a second fraction of the particulate material 13(b) is introduced into the sample chamber 2 and air is drawn through the particulate material 13(b) and the apertured ball valve 6. In FIG. 2(d) compression is then applied to the particulate material 13(b). FIG. 2(e) represents the result of the repeating the fractional filling/compression until the attenuation monitor (not shown) detects no further change in attenuation.

In use, a fraction of a particulate material 13(a) is introduced into the sample chamber 2 through the first pinch valve 9. The vacuum pump 7 continuously draws air through the particulate material and the apertured ball valve 6 of the frusto conical base region 4 of the sample chamber 2. The first pinch valve 9 is then closed and the flow control valve 11 is opened to allow compression of the particulate material 13. This process is repeated until the particulate material 13 has reached the desired level and until the attenuation monitor 12 detects no further change in attenuation.

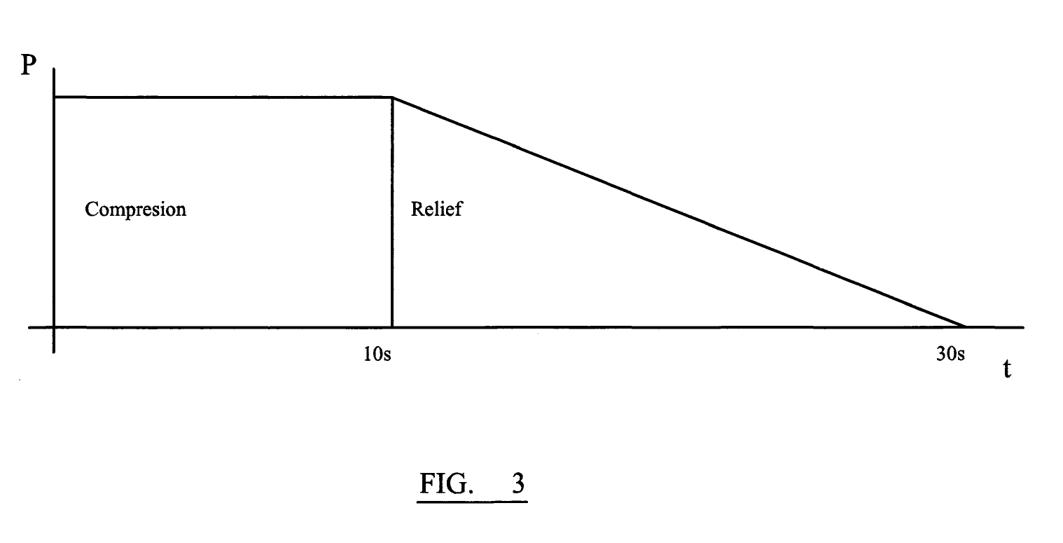

Referring to FIG. 3 a graph illustrates the profile of the compression of a sample over a period of 10 seconds followed by the linear gradient of relief of the compression over a period of 20 seconds.

1. A method of filling a sample chamber with a particulate material, said method comprising the steps of:
(i) opening an inlet valve to allow only a portion of the particulate material into the sample chamber;
(ii) drawing air through the particulate material from the base of the sample chamber;
(iii) closing the inlet valve is closed and opening a flow control valve to apply compression to the particulate material for a set period of time;
(iv) releasing the pressure; and
(v) repeating steps (i) to (iv) until the sample chamber is full.

2. A method according to claim 1 wherein the inlet valve comprises a T-piece connector which has a valve attached to it.

3. A method according to claim 1 wherein the inlet valve comprises a pinch valve.

4. A method according to claim 1 wherein a branch of the T-piece connector is connected to another T-piece to which a 3-way flow control valve and optionally another pinch valve are connected.

5. A method according to claim 1 wherein the lower portion of the sample chamber comprises a machined conical region.

6. A method according to claim 5 wherein the conical region comprises a frusto conical base region.

7. A method according to claim 5 wherein the conical region is provided with a ball valve.

8.-9. (canceled)

10. A method according to claim 7 wherein the conically shaped region is connected to a vacuum pump.

11.-12. (canceled)

13. A method according to claim 1 wherein after a portion of the particulate material sample is placed in the sample chamber the inlet valve is closed and the flow control valve is opened and compression is applied to the particulate material.

14.-16. (canceled)

17. A method according to claim 1 wherein the air drawn through the particulate material represents from about 1/40^{th} to about 1/10^{th} of the compression pressure.

18. (canceled)

19. A method according to claim 1 wherein the sample chamber is provided with an attenuation monitor.

20.-21. (canceled)

22. A sample chamber system suitable for a particulate material, said system comprising:
a sample chamber suitable for housing a particulate material;
the sample chamber being connected to an inlet valve suitable for the introduction of particulate material;
the sample chamber also being connected at its base to a vacuum pump suitable for drawing air through the particulate material from the base of the sample chamber;
the sample chamber being further connected to a flow control valve to allow compression of the particulate material.

23. A sample chamber according to claim 22 wherein the inlet valve comprises a T-piece connector which has a valve attached to it.

24. A sample chamber according to wherein the inlet valve comprises a pinch valve.

25. A sample chamber according to claim 22 wherein a branch of the T-piece connector is connected to another T-piece to which a 3-way flow control valve and optionally another pinch valve are connected.

26. A sample chamber according to claim 22 wherein the lower portion of the sample chamber comprises a machined conical region.

27. A sample chamber according to claim 26 wherein the conical region comprises a frusto conical base region.

28. A sample chamber according to claim 26 wherein the conical region is provided with a ball valve.

29. (canceled)

30. A sample chamber according to claim 28 wherein the conically shaped region and the ball valve are situated beneath the particulate material in the sample chamber.

31. A sample chamber according to claim 26 wherein the conically shaped region is connected to a vacuum pump.

32. (canceled)

33. A sample chamber according to claim 22 wherein the sample chamber is provided with an attenuation monitor.

34.-35. (canceled)
